(19) United States
(12) Patent Application Publication
(10) Pub. No.: US 2002/0027413 A1
(43) Pub. Date: Mar. 7, 2002

(54) Plasma display device

(75) Inventors: Yoshikazu Kanazawa, Kawasaki (JP); Seiki Kuroki, Higashimorokata (JP)

Correspondence Address: STAAS & HALSEY LLP, 700 11TH STREET, NW, SUITE 500, WASHINGTON, DC, 20001, US

(73) Assignee: FUJITSU HITACHI PLASMA DISPLAY LIMITED, Kawasaki (JP)

(21) Appl. No.: 09/929,048

(22) Filed: Aug. 15, 2001

(30) Foreign Application Priority Data
Sep. 1, 2000 (JP) 2000-266042

(51) Int. Cl. H01J 1/53

(52) U.S. Cl. 313/491

(57) ABSTRACT

A plasma display device having first and second substrates and a discharge gas filled therebetween includes first and second electrodes extending parallel to each other on a first substrate, and first and second discharge electrode parts extending from the first and second electrodes, respectively, so as to oppose each other. A discharge gap of a substantially constant width is formed between one of the first discharge electrode parts and one of the second discharge electrode parts, the ones opposing each other, the discharge gap being defined by first and second edge parts of the ones of the first and second discharge electrode parts, respectively. The first and second edge parts have lengths longer than widths of the ones of the first and second discharge electrode parts, the widths being measured in directions in which the first and second electrodes extend, respectively.

### BACKGROUND OF THE INVENTION

1. Field of the Invention

The present invention generally relates to flat-panel display devices, and more particularly to a plasma display device.

A plasma display device is a flat-panel display device of a light-emitting type that displays picture information by selectively inducing discharges in a gas filled between a pair of glass substrates.

It is important for the plasma display device to increase resolution and reduce power consumption at the same time.

2. Description of the Related Art

FIG. 1 is a diagram showing a basic structure of a conventional common plasma display device 10. A structure similar to this is disclosed in Japanese Laid-Open Patent Application No. 2000-195431.

The plasma display device 10 is basically defined by a display panel 11 and first through third driving circuits 12A through 12C that cooperate with the display panel 11. The display panel 11 includes first discharge electrodes X₁ through Xₘ and second discharge electrodes Y₁ through Yₘ that are alternately arranged parallel to each other and extend in the X direction of FIG. 1. Further, the display panel 11 includes address electrodes Z₁ through Zₙ that extend in the Y₁ direction of FIG. 1 to intersect the first and second discharge electrodes X₁ through Xₘ and Y₁ through Yₘ. The first discharge electrodes X₁ through Xₘ, the second discharge electrodes Y₁ through Yₘ, and the address electrodes Z₁ through Zₙ are selectively activated by the first through third driving circuits 12A through 12C, respectively.

For instance, an address voltage is applied between a selected one of the first discharge electrodes X₁ through Xₘ (X₂ in FIG. 1) and a selected one of the address electrodes Z₁ through Zₙ (Z₄ in FIG. 1), so that a discharge is started between the first discharge electrodes X₂ and the address electrode Z₄. Next, by applying a discharge-sustaining voltage between the first discharge electrodes X₂ and the adjacent second discharge electrode Y₂ by the driving circuits 12A and 12B, a discharge is started between the first discharge electrodes X₂ and the second discharge electrode Y₂ in a display cell selected by the address electrode Z₄. The discharge is maintained while the selected display cell is activated.

It is required for such a plasma display device to increase resolution by narrowing pitches between electrodes and reduce power consumption at the same time.

FIG. 2 is a sectional view of the conventional plasma display panel 11, whose type is referred to as an ALIS (Alternate Lighting of Surfaces) type, taken along the Y direction of FIG. 1.

The display panel 11 of FIG. 2 is defined by glass substrates 11A and 11B opposed to each other, and a discharge gas is filled between the glass substrates 11A and 11B.

The glass substrate 11A may be referred to as a front or display-side substrate facing a viewer of the display panel 11, and the glass substrate 11B may be referred to as a rear substrate provided across the glass substrate 11A from the viewer.

More specifically, the glass substrate 11A has the first and second discharge electrodes X₁ through Xₘ and Y₁ through Yₘ alternately arranged with the same pitch on its side opposing the glass substrate 11B. The glass substrate 11B has the address electrodes Z₁ through Zₙ formed on its side opposing the glass substrate 11A. The first and second discharge electrodes X₁ through Xₘ and Y₁ through Yₘ are formed of a transparent conductive film of ITO (In₂O₃.SnO₂), and the first discharge electrodes X₁ through Xₘ (ITO electrodes) has low-resistance bus electrodes x₁ through xₘ formed thereon, respectively. Similarly, the second discharge electrodes Y₁ through Yₘ (ITO electrodes) has low-resistance bus electrodes y₁ through yₘ formed thereon, respectively. On the other hand, the address electrodes Z₁ through Zₙ are formed of low-resistance metal patterns to extend in a direction to cross a direction in which the bus electrodes x₁ through xₘ or y₁ through yₘ extend. The first and second discharge electrodes X₁ through Xₘ and Y₁ through Yₘ and the bus electrodes x₁ through xₘ or y₁ through yₘ are covered with a dielectric film 11a on the glass substrate 11A, and the address electrodes Z₁ through Zₙ are covered with a dielectric film 11b on the glass substrate 11B. Further, as is not shown in the drawing, fluorescent material patterns of red, green, and blue are applied and formed on the dielectric film 11b in accordance with display pixels.

In the display panel 11 of the above-described structure, discharges caused between the glass substrates 11A and 11B excite the fluorescent material patterns to produce light, which is emitted through the glass substrate 11A as indicated by arrow in FIG. 2.

FIGS. 3(A) and 3(B) are plan views of patterns of the first and second discharge electrodes X₁ through Xₘ and Y₁ through Yₘ formed on the glass substrate 11A in another conventional ALIS-type plasma display device including the display panel 11. The X and Y directions of FIGS. 3(A) and 3(B) correspond to those of FIG. 1.

In FIG. 3(A), the first and second discharge electrodes X₁ through Xₘ and Y₁ through Yₘ are formed of series of repeated T-shaped ITO patterns (electrodes) XT and YT extending from longitudinal sides of the corresponding bus electrodes x₁ through xₘ and y₁ through yₘ on the glass substrate 11A, respectively. Each ITO pattern has a tip part T_{A} of a width A that extends in the extending direction of the bus electrodes x₁ through xₘ or y₁ through yₘ and a narrow neck part T_{B} connecting the tip part T_{A} and a corresponding one of the bus electrodes x₁ through xₘ or y₁ through yₘ. Each adjacent ITO patterns are arranged with a pitch corresponding to the resolution of the display panel 11, for instance, a pitch of 300 μm in FIG. 3(A), and a discharge is sustained in a gap (discharge gap) of a width g formed between each opposed ITO patterns XT and YT.

FIG. 4 is a diagram showing a structure of the glass substrate 11B of FIG. 2.

In FIG. 4, ribs 11C are formed with given pitches on the glass substrate 11B to extend in the Y direction of FIG. 1. Grooves G₁ through Gₙ are formed between the ribs 11C, and the address electrodes Z₁ through Zₙ are formed in the corresponding grooves G₁ through Gₙ. Further, the address electrodes Z₁ through Zₙ are covered with the dielectric film 11b in the corresponding grooves G₁ through Gₙ, and the fluorescent material patterns R, G, and B of red, green, and blue, respectively, are formed on the dielectric film 11b.

The glass substrate 11B of FIG. 4 is reversed to be placed on the glass substrate 11A so that, as shown in FIG. 5, the grooves G₁ through Gₙ formed between the ribs 11C contain the corresponding ITO patterns XT and YT.

In the plasma display panel 11 of the above-described structure, a drive current for a discharge can be reduced by narrowing a width of the neck part T_{B} of each ITO pattern XT or YT, and the discharge-sustaining voltage can be decreased by increasing the width A of the tip part T_{A} of each ITO pattern XT or YT, or by decreasing the width g of the discharge gap.

If the plasma display panel 11 is to offer 1024×1024 resolution, letting its diagonal be 42 in., a pitch between each adjacent address electrodes Z₁ through Zₙ must be set to 300 μm. However, in the case of such a high-resolution plasma display panel, where each rib 11C has a width of 60 μm and the tip part T_{A} of each ITO pattern XT or YT has the width A of 160 μm, each rib 11C and each ITO pattern XT or YT adjacent thereto are only slightly separated by a margin δ. Therefore, if a deviation between the positions between the glass substrates 11A and 11B exceeds the margin δ, each rib 11C, as shown in FIG. 6, overlaps the tip part T_{A} of each adjacent ITO pattern XT or YT, thus reducing the width A of the tip part T_{A}.

### SUMMARY OF THE INVENTION

It is a general object of the present invention to provide a plasma display device in which the above-described disadvantage is eliminated.

A more specific object of the present invention is to provide a high-resolution and low-power-consumption plasma display device that can be produced with a good fabrication yield.

The above objects of the present invention are achieved by a plasma display device having first and second substrates and a discharge gas filled therebetween, which plasma display device includes first and second electrodes extending parallel to each other on a first substrate, and first and second discharge electrode parts extending from the first and second electrodes, respectively, so as to oppose each other, wherein a discharge gap of a substantially constant width is formed between one of the first discharge electrode parts and one of the second discharge electrode parts, the ones opposing each other, the discharge gap being defined by first and second edge parts of the ones of the first and second discharge electrode parts, respectively, and the first and second edge parts have lengths longer than widths of the ones of the first and second discharge electrode parts, the widths being measured in directions in which the first and second electrodes extend, respectively.

According to the above-described plasma display device, at the same time that the effective length, that is, the length actually related to a discharge, of the edge part of each of the first and second discharge electrode parts is maintained so as to minimize a discharge starting voltage and a drive current for sustaining the discharge, the width of each of the first and second discharge electrode parts measured in the direction in which the first or second discharge electrode part extends can be smaller than the effective length of the edge part.

Additionally, in the above-described plasma display device, the discharge gap may have a length longer than or equal to 150 μm and shorter than 200 μm.

If the length of each of the first and second edge parts exceeds 200 μm, a discharge current increases while luminous efficacy decreases. Therefore, it is preferable to form the discharge gap of the constant width and the length longer than or equal to 150 μm and shorter than 200 μm between the ones of the first and second discharge electrode parts.

Further, in the above-described plasma display device, the discharge gap of the constant width and the length longer than or equal to 150 μm and shorter than 200 μm is formed between the ones of the first and second discharge electrode parts, and the first and second edge parts have the lengths longer than the widths of the ones of the first and second discharge electrode parts measured in the directions in which the first and second electrode parts extend, respectively. Therefore, if a pitch between each adjacent first or second discharge In electrode parts is narrowed, a sufficient margin can be secured therebetween. That is, according to the present invention, the plasma display device can be driven with a low voltage and low power consumption while eliminating a problem that some of the first and second discharge electrode parts may overlap ribs, or partition walls, formed on the second substrate because of an error in positioning the first and second substrates.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a schematic structure of a conventional plasma display device;

FIG. 2 is a sectional view of a plasma display panel employed in the plasma display device of FIG. 1;

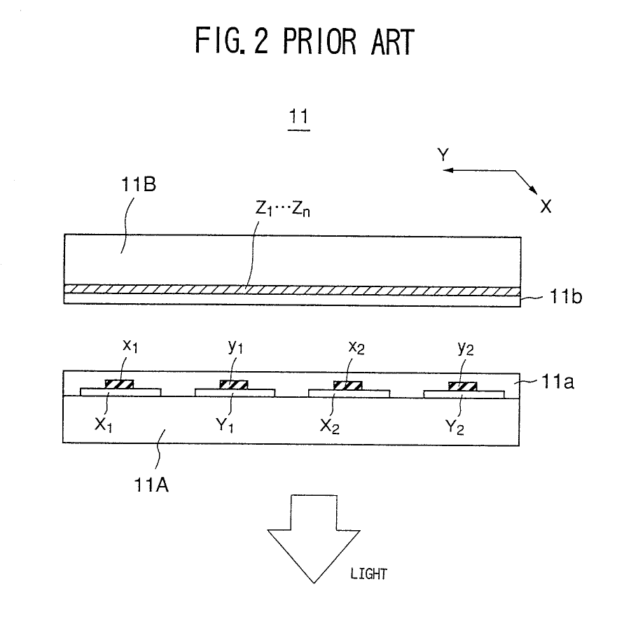

FIGS. 3(A) and 3(B) are diagrams for illustrating a structure of electrodes formed on a display-side substrate of the plasma display panel of FIG. 2;

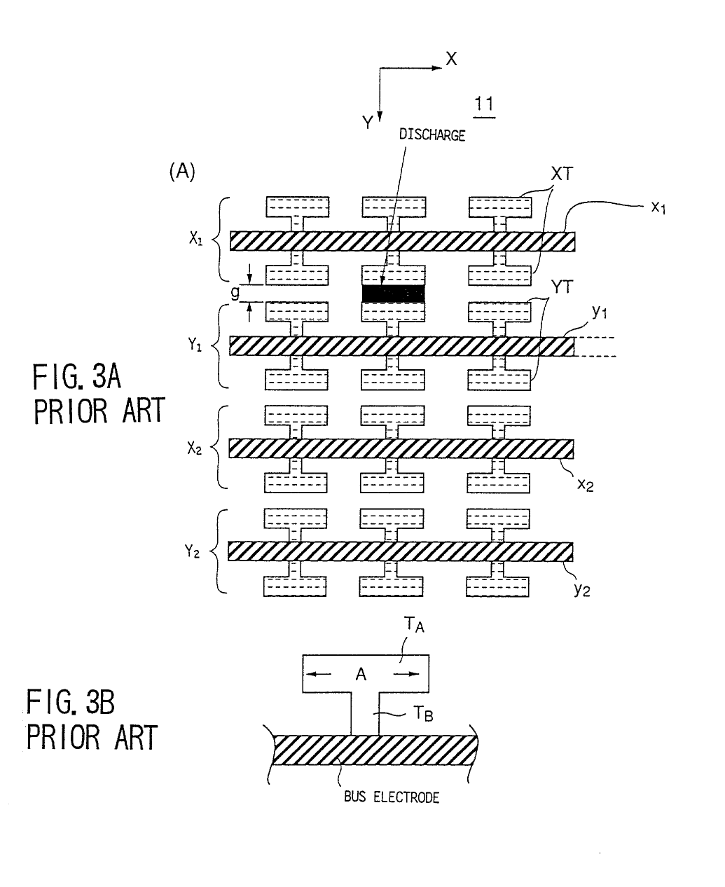

FIG. 4 is a perspective view of a rear substrate of the plasma display panel of FIG. 2;

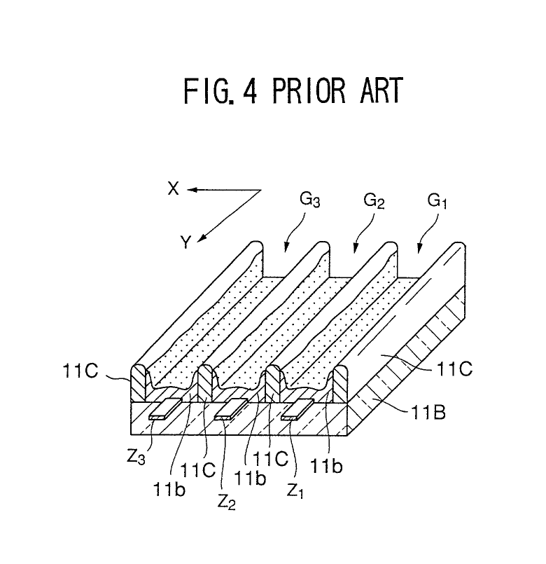

FIG. 5 is a plan view of the plasma display panel of FIG. 2 for illustrating a relation between the electrodes and ribs;

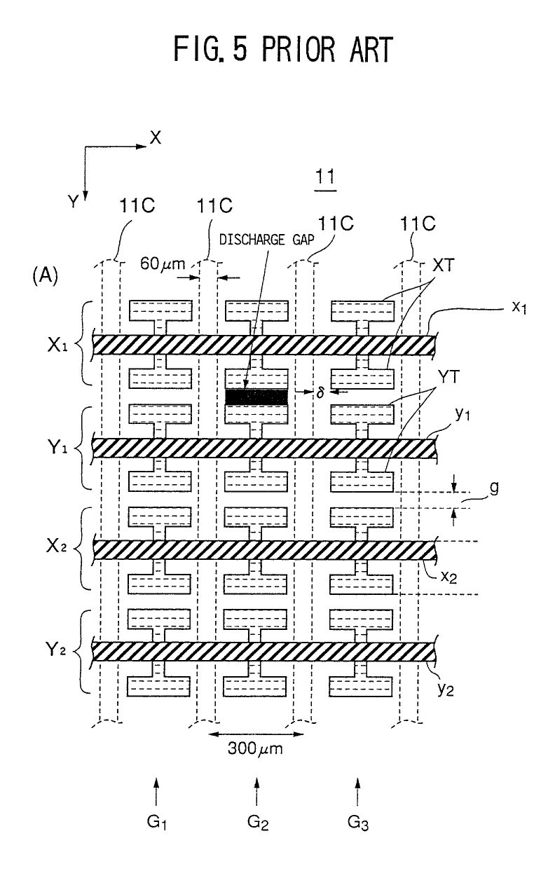

FIG. 6 is a plan view of the plasma display panel of FIG. 2 for illustrating a problem caused therein;

FIG. 7 is a diagram for illustrating a relation between a discharge starting voltage and a width of a tip part (an opposing edge part forming a discharge gap) of an ITO pattern in the plasma display panel of FIG. 2;

FIG. 8 is a diagram showing a structure of a plasma display panel according to a first embodiment of the present invention;

FIG. 9 is a diagram showing a structure of a plasma display panel according to a second embodiment of the present invention;

FIG. 10 is a diagram showing a structure of a plasma display panel according to a third embodiment of the present invention; and

FIG. 11 is a diagram showing a structure of a plasma display panel according to a fourth embodiment of the present invention.

### DETAILED DESCRIPTION OF THE PREFERRED EMBODIMENTS

[Principle]

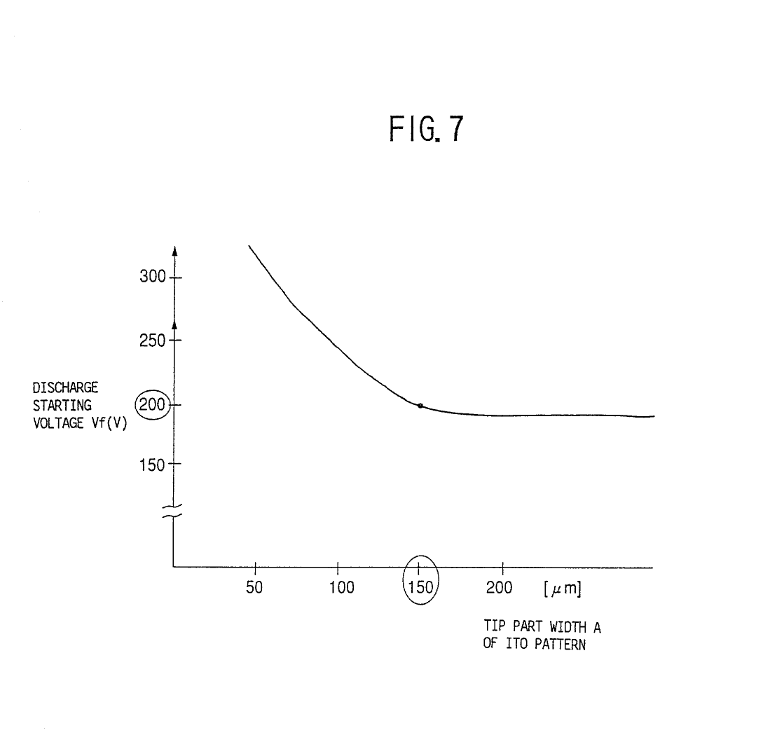

FIG. 7 is a diagram showing a relation between the width A of the tip part T_{A} of each ITO pattern XT or YT and a discharge starting voltage Vf, which relation is discovered with respect to the plasma display panel 11 by the inventors of the present invention. In FIG. 7, the width g of each discharge gap is set to 100 μm.

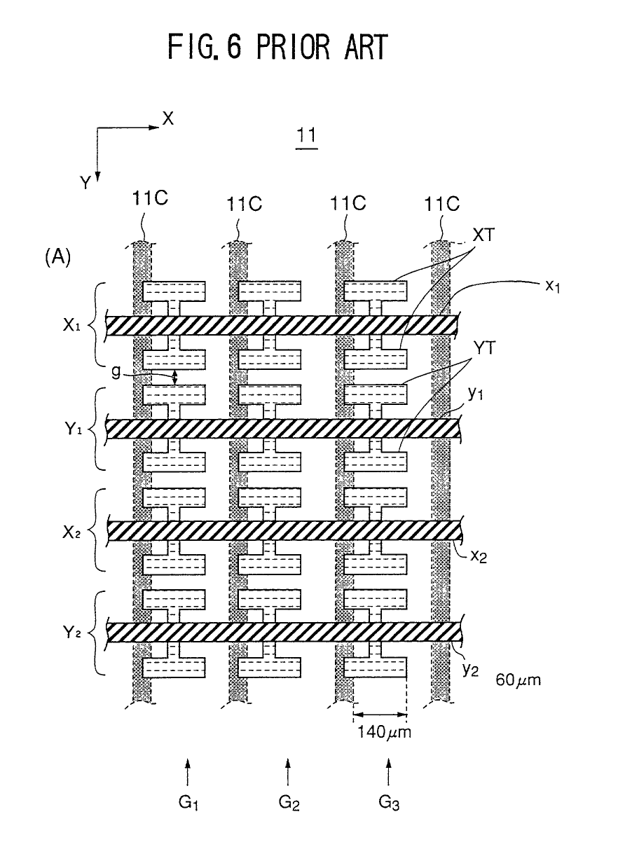

According to FIG. 7, the discharge starting voltage Vf is almost constant at or below 200 V if the width A of the tip part T_{A} is greater than or equal to 150 μm, while the discharge starting voltage Vf rises sharply as the width A decreases in a region where the width A is smaller than 150 μm. Thus, the relation shown in FIG. 7 indicates that the width A of the tip part T_{A} must be set to 150 μm or greater to minimize the discharge starting voltage Vf. The width A can be smaller than 150 μm especially in such a case as shown in FIG. 6, but FIG. 7 shows that a discharge voltage is unavoidably increased in such a case. On the other hand, the discharge voltage can be decreased by decreasing the width g of the discharge gap to below 100 82 m. In such a case, however, a discharge causes more damage to the tip part T_{A}, thus preventing the stable operation of the plasma display device 11.

A description will now be given, with reference to the accompanying drawings, of embodiments of the present invention.

[First embodiment]

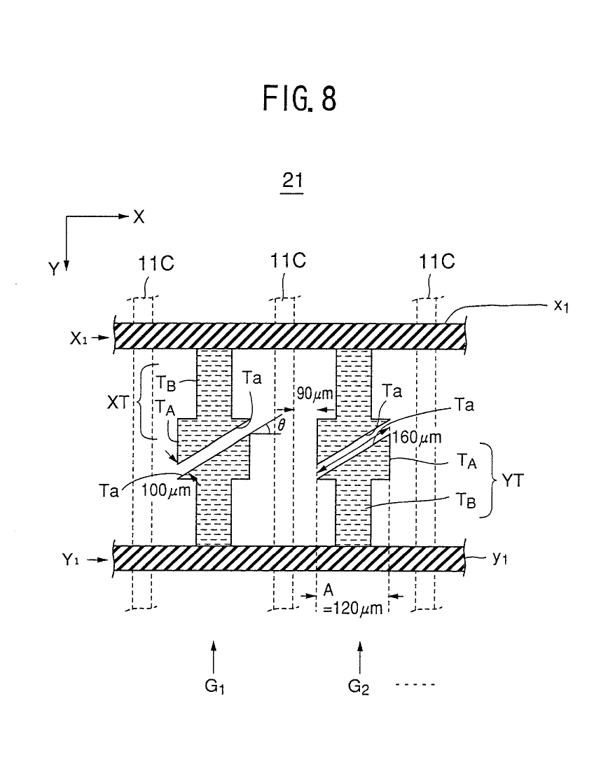

FIG. 8 is a diagram showing a structure of a plasma display panel 21 according to a first embodiment of the present invention. In FIG. 8, the same elements as those described previously are referred to by the same numerals, and a description thereof will be omitted.

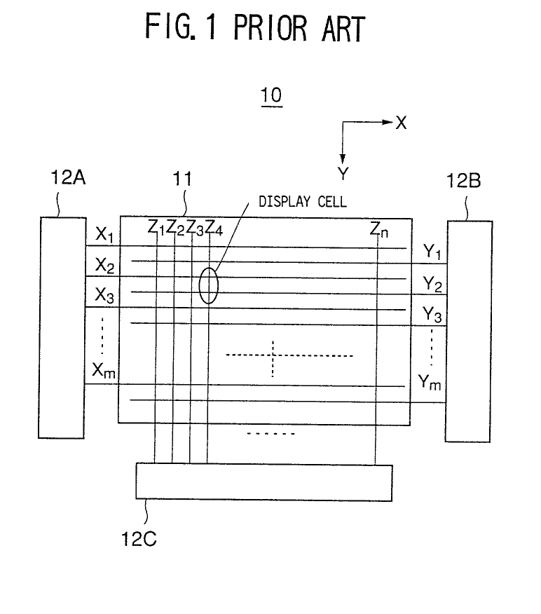

In FIG. 8, the plasma display panel 21 replaces the plasma display panel 11 in the plasma display device 10 of FIG. 1. Like the plasma display panel 11, the plasma display panel 21 includes the ITO discharge electrodes XT extending from the bus electrode x₁ toward the bus electrode y₁ and the ITO discharge electrodes YT extending from the bus electrode y₁ toward the bus electrode x₁ so as to oppose the corresponding ITO discharge electrodes XT. The ITO discharge electrodes XT and YT are formed in the corresponding grooves G₁ through Gₙ separated by the ribs 11C.

Each of the discharge electrodes XT and YT includes the tip part T_{A} and the neck part T_{B}. In this embodiment, the width A of the tip part T_{A} is reduced from conventional 160 to 120 μm so as to secure a (positioning) margin of 90 μm between each discharge electrode XT or YT and the rib 11C adjacent thereto.

On the other hand, in this embodiment, in order to avoid the problem of the increase of the discharge voltage resulting from the reduction of the width A of the tip part T_{A}, the tip part T_{A} is defined by an oblique line part (edge part) Tₐ forming an angle θ with the bus electrode x₁ or y₁. For instance, by setting the angle (inclination) θ of the oblique line part Tₐ at 41°, the oblique line part Tₐ is allowed to have a length of 160 μm. The angle θ is preferably set at greater than 30°. However, if the angle θ is set at such a great angle that the oblique line part Tₐ has a length greater than 200 μm, a discharge current is increased while luminous efficacy is decreased. Therefore, the angle θ is preferably set at 60° or smaller.

In FIG. 8, the opposed discharge electrodes XT and YT extending from the bus electrodes x₁ and y₁ are disposed so that the oblique line parts Tₐ of the discharge electrodes XT and YT form a discharge gap of 100 μm in width.

By this structure, at the same time that the width A of the tip part T_{A} of each discharge electrode XT or YT is decreased, the tip part (edge part) T_{A} where a discharge is actually caused can be ensured an optimum length or width that is greater than or equal to 150 μm and smaller than 200 μm. As a result, the problem of the increase of the discharge voltage and the accompanying increase of power consumption can be avoided.

[Second embodiment]

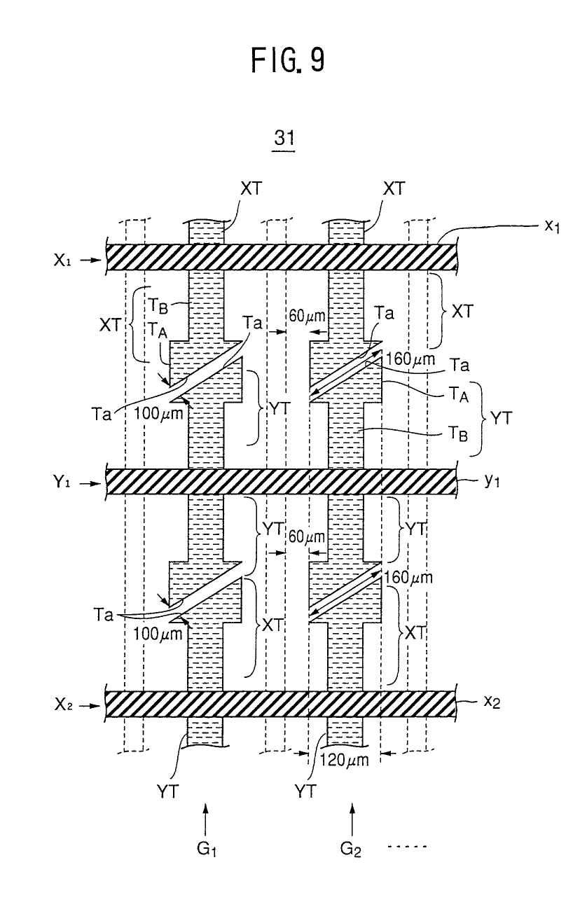

FIG. 9 is a diagram showing a structure of a plasma display panel 31 according to a second embodiment of the present invention. In FIG. 9, the same elements as those described previously are referred to by the same numerals, and a description thereof will be omitted.

According to FIG. 9, in this embodiment, in each of the grooves G₁ through Gₙ separated by the ribs 11C, the discharge electrodes XT and YT extend from both sides of the bus electrodes x₁ and y₁, respectively. Therefore, the same electrode arrangement of the discharge electrodes XT and YT as that formed between the bus electrodes x₁ and y₁ is formed between the bus electrode y₁ and the bus electrode x₂ adjacent thereto.

In the plasma display panel 31 of the above-described structure, a discharge can be also caused between the bus electrodes y₁ and x₂ as between the bus electrodes x₁ and y₁. Therefore, the plasma display panel 31 can offer resolution twice that of a structure formed by repeating the electrode structure of FIG. 8.

[Third embodiment]

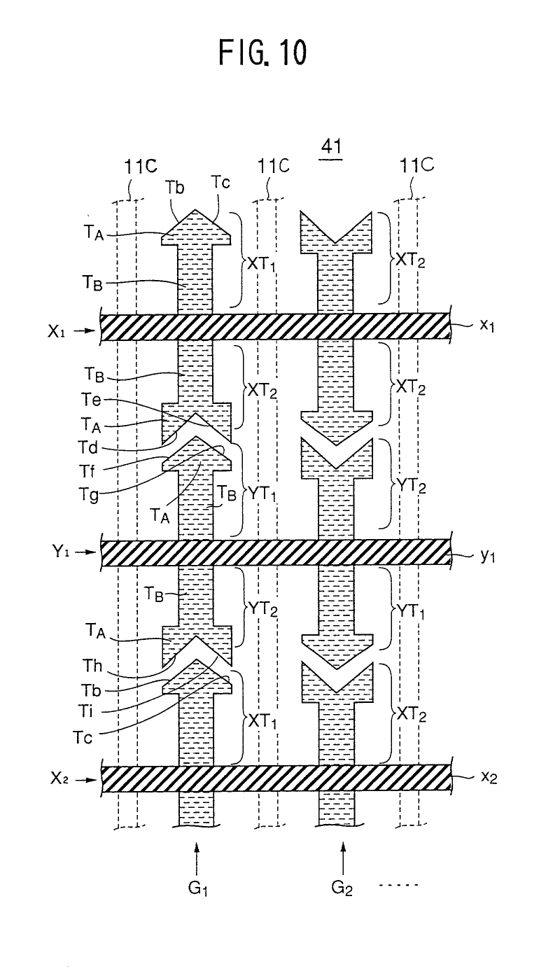

FIG. 10 is a diagram showing a structure of a plasma display panel 41 according to a fourth embodiment of the present invention. In FIG. 10, the same elements as those described previously are referred to by the same numerals, and a description thereof will be omitted.

According to FIG. 10, in this embodiment, each discharge electrode XT includes a discharge electrode XT₁ extending from the bus electrode x₁ in a first direction and a discharge electrode XT₂ extending from the bus electrode x₁ in a second direction opposite to the first direction. The discharge electrode XT₁ has a convex tip part T_{A} defined by oblique line parts T_{b} and T_{c} (forming an edge part of the discharge electrode XT₁), while the discharge electrode XT₂ has a concave tip part T_{B} defined by oblique line parts T_{d} and Tₑ (forming an edge part of the discharge electrode XT₂). Similarly, in this embodiment, each discharge electrode YT includes a discharge electrode YT₁ extending from the bus electrode y₁ toward the bus electrode x₁ and a discharge electrode YT₂ extending from the bus electrode y₁ in the opposite direction. The discharge electrode YT₁ has a convex tip part T_{A} defined by oblique line parts T_{f} and T_{g} (forming an edge part of the discharge electrode YT₁), while the discharge electrode YT₂ has a concave tip part T_{B} defined by oblique line parts Tₕ and Tᵢ (forming an edge part of the discharge electrode YT₂). The same discharge electrodes are formed with respect to other bus electrodes not shown in the drawing.

The discharge electrodes XT₁, YT₁, XT₂, YT₂, . . . are formed along the groove G₁ defined by corresponding two of the ribs 11C and having the address electrode Z₁ formed therein. The discharge electrodes XT₁, YT₁, XT₂, YT₂, . . . are also formed in the adjacent groove G₂ but arranged in the reverse orientation.

In the structure shown in FIG. 10, the oblique line parts T_{d} and Tₑ of the discharge electrode XT₂ oppose the oblique line parts T_{f} and T_{g} of the discharge electrode YT₁, respectively, so that a discharge gap of approximately 100 μm is formed almost evenly therebetween. Similarly, the oblique line parts T_{b} and T_{c} of the discharge electrode XT₁ oppose the oblique line parts Tₕ and Tᵢ of the discharge electrode YT₂, respectively, so that a discharge gap of approximately 100 μm is formed almost evenly therebetween.

In the plasma display panel 41 of the above-described structure, by forming, by the oblique line parts, the edge part of each of the discharge electrodes XT₁, YT₁, XT₂, and YT₂ which edge part defines the discharge gap, the total length of the edge part with respect to the given width A of the tip part T_{A} can be made longer than in the above-described plasma display panel 21 or 31 whose discharge electrode XT or YT has its tip part T_{A} formed to have the single oblique line part Tₐ. This also indicates that, if the total length of the edge part of each of the discharge electrodes XT₁, YT₁, XT₂, and YT₂ is set to a value within 150 to 200 μm, for instance, to 160 μm, a larger positioning margin can be secured than in the above-described embodiments by making the width A narrower than in the above-described embodiments.

[Fourth embodiment]

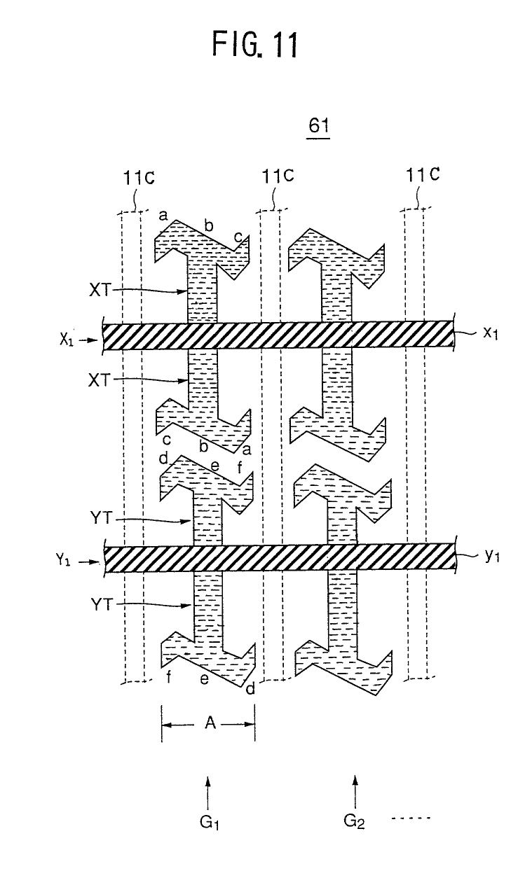

FIG. 11 is a diagram showing a structure of a plasma display panel 61 according to a fourth embodiment of the present invention. In FIG. 11, the same elements as those described previously are referred to by the same numerals, and a description thereof will be omitted.

According to FIG. 11, the plasma display panel 61 of this embodiment is a variation of the plasma display panel 41 of FIG. 10, and the edge part of each discharge electrode XT which part forms a discharge gap together with an opposing one of the discharge electrodes YT is defined by three oblique line parts a, b, and c. Similarly, the edge part of each discharge electrode YT which part forms a discharge gap together with an opposing one of the discharge electrodes XT is defined by three oblique line parts e, f, and g. This structure allows a discharge gap of approximately 100 μm to be formed almost evenly between each of the oblique line parts a and d, b and f, and c and g. If a patterning process permits, by providing each discharge electrode XT or YT with any complicated shape, it is possible to provide each discharge electrode XT or YT with an effective width of 160 μm while decreasing the width A of the tip part T_{A}.

In the above-described embodiments, the edge part of each discharge electrode has a width equal to or larger than 150 μm and a discharge gap of approximately 100 μm is formed between each pair of opposed discharge electrodes. However, these values are optimum values for the plasma display panels according to the present invention, and it is natural that these values should vary under different conditions of a material, a dielectric constant, a gas pressure, and a gas composition.

The present invention is not limited to the specifically disclosed embodiments, but variations and modifications may be made without departing from the scope of the present invention.

The present application is based on Japanese priority application No. 2000-266042 filed on Sep. 1, 2000, the entire contents of which are hereby incorporated by reference.

What is claimed is:

1. A plasma display device having first and second substrates and a discharge gas filled therebetween, the plasma display device comprising:
first and second electrodes extending parallel to each other on a first substrate; and
first and second discharge electrode parts extending from the first and second electrodes, respectively, so as to oppose each other,
wherein:
a discharge gap of a substantially constant width is formed between one of the first discharge electrode parts and one of the second discharge electrode parts, the ones opposing each other, the discharge gap being defined by first and second edge parts of the ones of the first and second discharge electrode parts, respectively; and
the first and second edge parts have lengths longer than widths of the ones of the first and second discharge electrode parts, the widths being measured in directions in which the first and second electrodes extend, respectively.

2. The plasma display device as claimed in claim 1, wherein the discharge gap has a length longer than or equal to 150 μm and shorter than 200 μm.

3. The plasma display device as claimed in claim 1, wherein:
the first edge part extends obliquely with respect to the direction in which the first electrode extends; and
the second edge part extends substantially parallel to the first edge part and obliquely with respect to the direction in which the second electrode extends.

4. The plasma display device as claimed in claim 3, wherein the first edge part forms an angle θ with respect to the direction in which the first electrode extends, the angle θ satisfying a condition 30°≦θ≦60°.

5. The plasma display device as claimed in claim 1, wherein the first and second edge parts are defined by a plurality of sides forming angles with respect to the direction in which the first and second electrode extend, respectively.

6. The plasma display device as claimed in claim 1, wherein:
the first edge part has a convex shape; and
the second edge part has a concave shape matching the first edge part.

7. The plasma display panel as claimed in claim 1, wherein:
the first and second electrodes are repeatedly formed alternately; and
the first discharge electrode parts extend from first and second parallel sides of the first electrode and the second discharge electrode parts extend from first and second parallel sides of the second electrode.

8. The plasma display device as claimed in claim 7, wherein each of the first discharge electrode parts includes first and second electrode patterns extending from the first and second sides of the first electrode, respectively, the first electrode pattern forming a first discharge gap with one of the second discharge electrode parts which one opposes the first electrode pattern, the second electrode pattern forming a second discharge gap with one of the second discharge electrode parts which one opposes the second electrode pattern, the second discharge gap being substantially equal to the first discharge gap in size.
